(19) United States
(12) Patent Application Publication
(10) Pub. No.: US 2008/0061159 A1
(43) Pub. Date: Mar. 13, 2008

(54) Electrical heater and vehicle air conditioner

(75) Inventors: Reijiro Okano, Chiryu-city (JP); Yoshinori Akiyama, Okazaki-city (JP); Eiichi Hasada, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/896,815

(22) Filed: Sep. 6, 2007

(30) Foreign Application Priority Data
Sep. 11, 2006 (JP) JP 2006-245266
Apr. 5, 2007 (JP) JP 2007-99040

(51) Int. Cl. B60H 1/00

(52) U.S. Cl. 237/12.3 A

(57) ABSTRACT

A heater with several common and inexpensive parts can be used in different vehicles having different heating requirements. Heating partition members for receiving and fixing PTC elements and non-heating partition members are substantially the same. The partition members are spaced apart at substantially equal intervals between a pair of frame members. Metal heat exchange fins are placed in a heat exchange air flow passage adjacent to the heating partition member. A resin dummy member is placed in non-heat exchange air flow passage located between non-heating partition members. The number of heating elements can be varied to suit vehicles of different sizes.

### CROSS REFERENCE TO RELATED APPLICATION

This application is based on Japanese Patent Applications No. 2006-245266 filed on Sep. 11, 2006, and No. 2007-99040 filed on Apr. 5, 2007, the disclosure of which is incorporated herein by reference.

### TECHNICAL FIELD

The present invention relates to an electrical heater for generating heat by supplying electrical power and a vehicle air conditioner using the electrical heater.

### BACKGROUND

U.S. Pat. No. 5,562,844 discloses a conventional electrical heater, which includes a pair of frames and a plurality of partition members (resin frames). The plurality of partition members are generally planar and are located between a pair of frames, which form a reinforcing structure. Fixing portions for fixing a positive temperature coefficient thermistors (PTC elements), which are heating elements of a known type, are formed on the partition members. Air flow passages are formed between the partition members and between the partition members and the frame.

Furthermore, the electrical heater of U.S. Pat. No. 5,562,844 includes heat exchange fins placed in the air flow passages. The heat exchange fins facilitate heat exchange between the PTC elements and the air. Thus, the electrical heater improves heat transfer from the PTC elements to the air.

When this kind of electrical heater is applied to a vehicle air conditioner and used as a heating device for air that enters a vehicle passenger compartment, the heating capacity or heat output required of the electrical heater is different depending on the vehicle and, for a given vehicle, the heating requirements may vary depending on the climate of the location where the vehicle is sold. That is, different vehicles have different sized passenger compartments and different heating requirements. Further, even for a passenger compartment of one size, the heating requirements may differ according to the geographic location of the vehicle. To lower the cost of producing the heater, it is preferred that a single fixed frame and electrical heater shape be employed in various different vehicles.

The number of the PTC elements may be changed to adjust the heating capacity of the electrical heater. However, in this case, the heat exchange fins placed in the air flow passage between partitioned members that are not adjacent to a PTC element do not facilitate heat transfer. In this kind of electrical heater, corrugated fins, which are made of sheet metal that has superior heat transfer characteristics (for example, aluminum alloy or copper), are employed. The existence of unused heat exchange fins increases the cost of the electrical heater.

### SUMMARY

In view of the above-described problems, it is an object to provide an electrical heater which adjusts the heat output without changing the frame or shape, and costs are reduced.

In accordance with one exemplary embodiment, an electrical heater includes a pair of frame members that are spaced apart by a predetermined distance, a heating element that generates heat when energized, a heating partition member for partitioning a space formed between the frame members and for fixing the heating element, a non-heating partition member for partitioning a space formed between the frame members, a heat exchange air flow passage located adjacent to the heating partition member, a non-heating exchange portion located adjacent to the non-heating partition member and not adjacent to the heating partition member, a metal heat exchange member for facilitating heat transfer between the heating element and the air. The heat exchange member is located only in the heat exchange air flow passage.

According to this aspect, the heating partition member and the non-heating partition member are located a between the frames located in a predetermined interval. By adjusting the number of heating partition members and heating elements, the heat output can easily adjust without changing the frame or shape of the whole electrical heater.

Furthermore, because the relatively expensive metal heat exchange member is not placed in the non-heat exchange portion, the cost of the electrical heater is reduced.

Preferably, the non-heat exchange portion is an air flow passage through which air can pass.

Preferably, the non-heating partition member is one of a pair of non-heating partition members, and the non-heat exchange portion is located between the non-heating partition members

Preferably, the heating partition member and the non-heating partition member are substantially the same, and the heating partition member includes a portion for receiving the heating element.

Preferably, the heating partition member is identical to the non-heating partition member except that no heating element is received by the non-heating partition member.

Therefore, because the heating partition member and the non-heating partition member can be made by the same member, costs are reduced.

Preferably, the electrical heater further includes a ventilation flow resistance member placed in the non-heat exchange air flow passage. The ventilation flow resistance member creates ventilation flow resistance against the air passing though the non-heat exchange air flow passage. The ventilation flow resistance of the non-heat exchange air flow passage per unit area is substantially the same as that of the heat exchange air flow passage.

Therefore, even though the heat exchange members is only located in the heat exchange air flow passage, the ventilation flow resistance of the electrical heater can be made the same as a heater in which all air flow passages are heat exchange air flow passages.

In this situation, the phrase “substantially the same” does not mean that the ventilation flow resistance of the heat exchange air flow passage in which the heat exchange member is located and the ventilation flow resistance of the non-heat exchange air flow passage in which the heat exchange member is not located are identical, but also includes situations where there are minute differences between the ventilation flow resistance of the heat exchange and non-heat exchange air flow passages as a result of a production error or an assembly error.

Preferably, the ventilation flow resistance member is generally ladder-shaped. Therefore, according to the change of the number and shape of pillars of the ladder shape, the ventilation flow resistance of the ventilation flow resistance member can be adjusted easily.

Preferably, the ventilation flow resistance member is made with resin. Therefore, costs are further reduced.

Preferably, the heating element is a PTC element.

Preferably, the electrical heater includes a ventilation flow resistance member placed in the non-heat exchange air flow passage and for causing ventilation flow resistance against the air passing though the non-heat exchange air flow passage. The ventilation flow resistance member comprises an outer frame member defining the non-heat exchange air flow passage. The outer frame member serves as the non-heating partition member. A pillar is placed between opposed sections of the outer frame member.

Preferably, the electrical heater forms part of a vehicle air conditioner.

It accordance with another aspect of the invention, an electrical heater includes a pair of frame members that are spaced apart by a predetermined distance, a plurality of heating elements that generate heat when energized, a plurality of partition members for partitioning a space formed between the frame members, a heat exchange air flow passage, a non-heat exchange air flow passage, and a metal heat exchange member for facilitating heat transfer between the heating element and the air. Each of the partition members is adapted to receive at least one of the heating elements. The heat exchange air flow passage is located adjacent to one of the heating elements. The non-heat exchange air flow passage is spaced apart from each of the heating elements. The heat exchange member is located only in the heat exchange air flow passage.

### BRIEF DESCRIPTION OF THE DRAWINGS

Other objects, features and advantages will become more apparent from the following detailed description made with reference to the accompanying drawings, in which:

FIG. 1 is a diagrammatic sectional view of an interior air conditioning unit of a vehicle air conditioner according to an exemplary embodiment;

FIG. 2 is an overall perspective view showing a diagrammatic configuration of an electrical heater according to an exemplary embodiment;

FIG. 3 is a top view of a heating partition member of an electrical heater according to the exemplary embodiment of FIG. 2;

FIG. 4 is an exploded perspective view of area E of FIG. 2;

FIG. 5 is an exploded perspective view of area F of FIG. 2; and

FIG. 6 is an exploded perspective view showing a part of an electrical heater according to another exemplary embodiment.

### DETAILED DESCRIPTION OF THE PREFERRED EMBODIMENTS

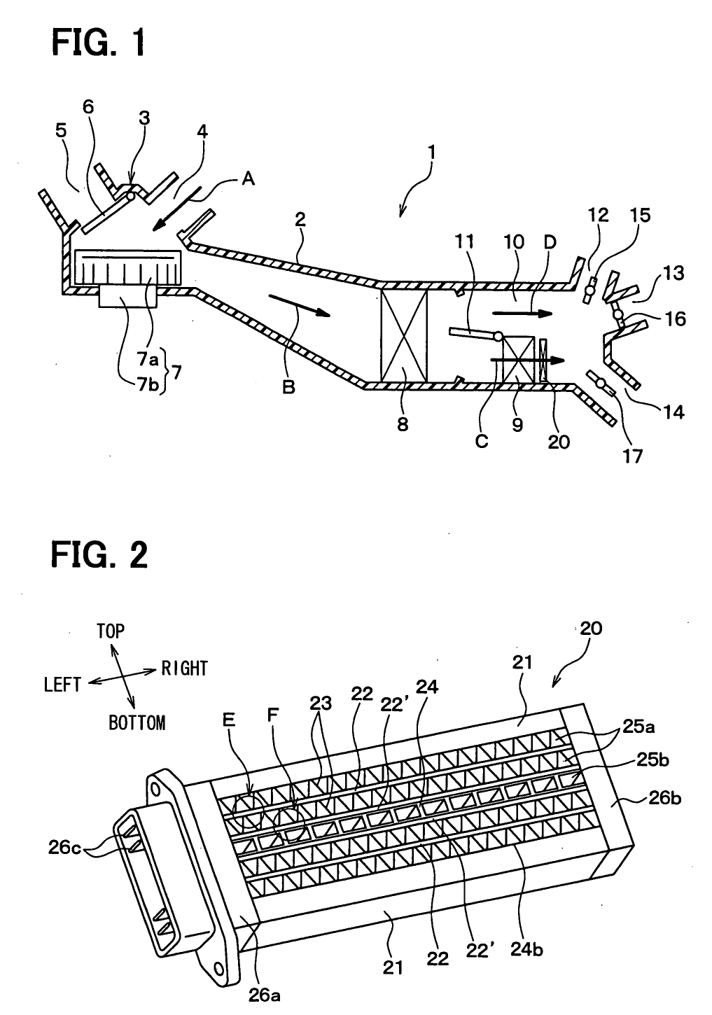

With reference to FIGS. 1-4, a first exemplary embodiment will be described. FIG. 1 shows a configuration in which an electrical heater 20 is applied to a vehicle air conditioner.

The vehicle air conditioner is installed a vehicle in which it is difficult to raise the engine coolant temperature when the engine is first started (for example, a hybrid vehicle or a diesel engine vehicle) or a vehicle used in a cold climate. The vehicle air conditioner employs an electrical heater 20 as an auxiliary heating device for heating air to be forced into the passenger compartment when the passenger compartment is first heated.

The interior air conditioning unit 1 is placed inside of a dashboard (an instrument panel) of the passenger compartment of the vehicle. The interior air conditioning unit 1 includes a case 2 made of resin. The case 2 forms an outer part of the unit 1. An air flow passage through which air flows toward the passenger compartment is formed in the case 2. An inside and outside air switching box 3 is placed at the most upstream portion of the case 2.

The inside and outside air switching box 3 includes an inside air introducing inlet 4, outside air introducing inlet 5, and an inside and outside air switching door 6. The inside air introducing inlet 4 is an inlet that permits inside air (air in the passenger compartment) to enter the inside of the case 2. The outside air introducing inlet 5 is an inlet that permits outside air (air from outside of the passenger compartment) to enter the inside of the case 2. The inside and outside air switching door 6 is placed to pivot in the inside and outside air switching box 3. The inside and outside air switching door 6 is an inside and outside air switching means, which is driven by an unillustrated servo motor.

More specifically, the mode of the inside and outside air switching box 3 can be changed among any of an inside air mode, in which inside air is introduced from the introducing inlet 4, a outside air mode, in which outside air is introduced from the outside air introducing inlet 5, and an inside/outside air mode, in which inside air and outside air are introduced at the same time because of the rotational position of the inside and outside air switching door 6. FIG. 1 shows the inside air mode in which inside air is introduced into case 2 as shown by arrow A.

A electrical blower 7, which forces air into the passenger compartment is placed at an upstream end of the case 2 in the inside and outside air switching box 3. The blower 7 blows air in the direction of the arrow B by rotationally driving a well-known centrifugal multi-blade fan 7a with an electric motor 7b. An evaporator, which is a cooling heat exchanger that cools the air, is placed downstream of the blower 7.

The evaporator 8 is one of the elements of a refrigerating circuit (not shown). The evaporator 8, as is well-known, cools air by absorbing heat from the air blown by the blower 7 when low pressure refrigerant, which flows into evaporator 8, evaporates. A heater core 9 heats the air (cool air) that has passed through the evaporator 8 is placed downstream of the evaporator 8.

The heater core 9 is a heat exchanger for heating the air (cool air) after the air has passed through the evaporator 8 by using engine coolant (the engine coolant circuit is not illustrated.). A bypass passage 10 is formed on one side of the heater core 9 in the case 2. In the bypass passage 10, air (cool air) that has passed through the evaporator 8 bypasses the heater core 9.

In the vehicle air conditioner of the present embodiment, a electrical heater 20 is placed at the downstream side of the heater core 9. The electrical heater 20 is an auxiliary heater for generating heat with electrical power from an unillustrated control unit and for heating the air that has passed though the heater core 9 when the heater core 9 cannot sufficiently heat the air from the evaporator 8. Details of the electrical heater 20 are described below.

As for the control of the electrical heater 20 by the control unit, for example, the following control may be adopted. The control unit (unillustrated) detects the temperature of the engine coolant passing though the heater core 9. When the temperature is lower than a predetermined temperature, the control unit determines that the heater core 9 cannot sufficiently heat the air that has passed though the evaporator 8, and the control unit supplies electrical power to the heater 20.

An air mix door 11 is placed between the evaporator 8 and the heater core 9. The air mix door 11 can pivot in the case 2. The rotational position (open degree) of the air mix door 11 can be adjusted by driving an unillustrated servo motor.

According to the open degree of the air mixing door 11, a flow ratio of the air quantity passing through the heater core 9 and the electrical heater 20 (a warm air quantity as shown by arrow C) and the air quantity of air passing through the bypass passages 10 (a cool air quantity as shown by arrow D) is adjusted. Because the warm air (arrow C) and the cold air (arrow D) are mixed at the downstream side of the heater core 9, the electrical heater 20, and bypass passages 10, and are forced into the passenger compartment, the temperature of the air entering the passenger compartment is adjusted by the adjustment of the flow ratio.

Three kinds of outlets 12-14 are placed at the most downstream end of the case 2. One of the outlets 12-14 is a defroster outlet 12 for blowing conditioned air toward a front window glass (front windshield) of the vehicle. Another of the outlets 12-14 is a face outlet 13 for blowing conditioned air toward the faces of passengers. Another of the outlets 12-14 is a foot outlet 14 for blowing conditioned air toward the feet of the passengers.

A defroster door 15, a face door 16 and a foot door 17 are placed to pivot, respectively, at the upstream side of those outlets 12-14. The doors 15-17 are rotationally operated to open and close by a common servo motor (not shown) through an unillustrated link structure. FIG. 1 shows a defroster mode in which both the defroster door 15 and the foot door 17 are open at the same time.

Next, according to FIGS. 2-4, details of the electrical heater 20 are described. FIG. 2 is an overall diagrammatic perspective view showing the configuration of the electrical heater 20 of the present embodiment. The top and bottom, right and left arrows of FIG. 2 show directions in the state in which the electrical heater 20 is installed in the vehicle air conditioner.

The electrical heater 20 includes a pair of frame members 21, a plurality of partition members 22, 22′, which are stacked between the frames 21, heat exchange fins 23, which are placed an air flow passage 25a described below, and a resin dummy member 24 placed an air flow passage 25b described below. The electrical heater 20 is a so-called PTC heater that generates heat by energizing PTC elements 22a, which are fixed to a heating partition member 22 described below.

The frame members 21 form the outer shape of the electrical heater 20 and reinforce the perimeter of the electrical heater 20. Unillustrated springs, which apply force inwardly in stacking direction (the top to bottom directions) of the partition members 22, 22′, the heat exchange fins 23 and the resin dummy member 24, are provided in the frame 21. The stack of parts 22, 22′, 23, 24 is fixed in place by the force of the springs.

Housings 26a, 26b are respectively fitted to the pair of frame members 21 from the direction (left and right direction in FIG. 2) perpendicular to the stacking direction. Thus, the housings determine the space between the frame members 21.

The partition members 22, 22′ partition a space formed between the frame members 21. The partition members 22, 22′ are composed of resin materials having heat resistance (for example, a polyamide synthetic fiber or polybutadiene tere phthalate (PBT)). The partition members 22, 22′ include heating partition members 22, to which are fixed PTC elements 22a described below, and non-heating partition members 22′, to which no PTC elements 22a are fixed.

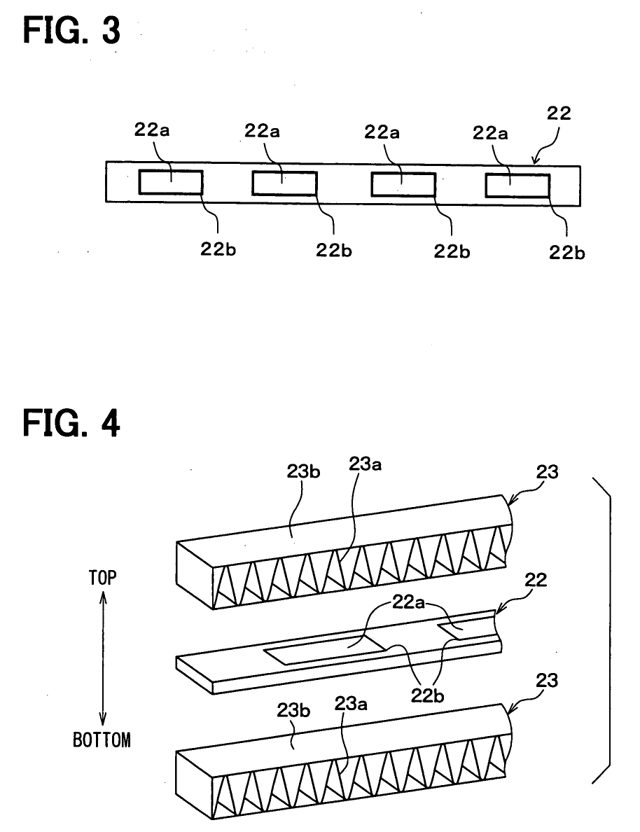

Details of the partition members 22 are shown in FIG. 3. FIG. 3 is a top view of one of the heating partition members 22. As shown in FIG. 3, the heating partition members 22 are composed of thin plate shape members that extend in the longitudinal direction of the frame 21. Holes 22b that penetrate through in the stacking direction (top to bottom direction in FIG. 2) are formed on the heating partition members 22. Each hole 22b functions to receive and fix one of the PTC elements 22a.

The heating partition member partition members 22 function as frames or supports for the PTC elements 22a. Though four holes 22b are shown in FIG. 3, the number of holes 22b is not so limited. In FIG. 3, though PTC elements 22a are received and fixed in all of four holes 22b, there may be a hole 22b in which no PTC element 22a is received to adjust the heat output of the electrical heater 20.

On the other hand, the non-heating partition members 22′ are planar members that are shaped the same as the heating partition members 22. There are no PTC elements 22a in any of the holes 22b in the non-heating partition members 22′. In other words, the non-heating partition members 22′ are the same as the heating partition members 22 except for the absence of the PTC elements 22a.

Each PTC element 22a is a positive temperature coefficient thermistor having a self temperature control function. Specifically, the temperature of each of the PTC elements 22 arises immediately when it is energized. The electrical resistance value increases rapidly to limit the electrical current and to maintain the heat generation when the temperature reaches a predetermined temperature (a Curie point). The PTC elements 22a may be referred to herein as heating elements.

The partition members 22, 22′ are stacked at predetermined intervals, such that the partition members 22, 22′ are spaced at equal intervals from one another and from the frame members 21 as shown in FIG. 2. Air flow passages 25a, 25b through which air passes are formed between adjacent pairs of the partition members 22, 22′ and between the frame members 21 and the partition members 22 that are adjacent to the frame members 21. Two non-heating partition members 22′ are placed next to each other as shown in FIG. 2. Heating partition members 22 are placed between the frame members 21 and the non-heating partition members 22′.

Among the air flow passages 25a, 25b, the air flow passages that are adjacent to a heating partition member 22 that holds at least one PTC element 22a are heat exchange air flow passages 25a in which air is heated by the heat of the PTC elements 22a. In other words, the air flow passages located between the frame members 21 and the non-heating partition members 22′ are heat exchange air flow passages 25a. Among the air flow passages 25a, 25b, the air flow passage located between the two non-heating partition members 22′ is a non-heat exchange air flow passage 25b. In other words, the air flow passage other than the heat exchange air flow passages 25a is the non-heat exchange air flow passage 25b.

Heat exchange members 23 facilitate heat exchange between the PTC elements 22a and the air. The heat exchange members 23 are only located in the heat exchange air flow passages 25a.

As shown in an exploded perspective view of FIG. 4, each heat exchange member 23 includes a corrugate fin 23a, which is a thin metal plate (for example, aluminum alloy or copper)that has superior heat transfer characteristics. Each fin 23a has the shape of a wave pattern. Metal plates 23b (aluminum alloy plate in the present embodiment) made of the same metal as the corrugate fins 23a surround the fins 23a as shown in FIG. 4. Each corrugate fin 23a is inserted between the metal plates 23b. The metal plates 23b hold the fin 23a in a certain shape and form a contact area for making surface-to-surface contact with the partition member 22, 22′. The metal plates 23b and the corrugate fins 23a are brazed.

A resin dummy member 24 is placed in the non-heat exchange air flow passage 25b. The resin dummy member 24 is a ventilation flow resistance member formed such that the ventilation flow resistance of the non-heat exchange air flow passage 25b is equivalent to the ventilation flow resistance that would exist if a heat exchange fin 23 were placed in the non-heat exchange air flow passage 25b. In other words, the ventilation flow resistance of the non-heat exchange air flow passage 25b per unit area is substantially the same as that of the heat exchange air flow passage 25a.

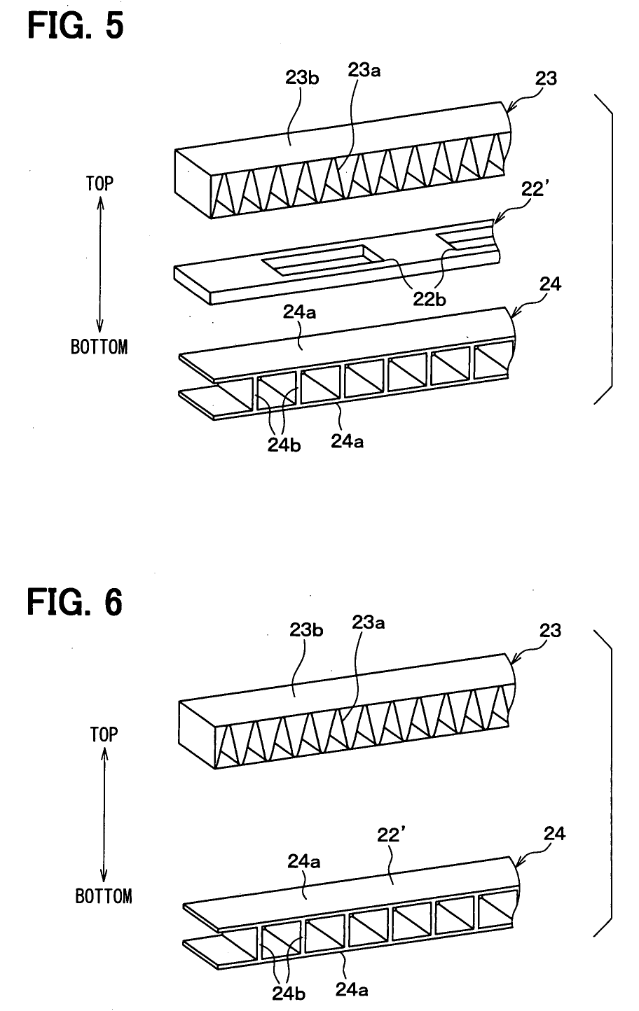

The resin dummy member 24 is made of resin material having same heat-resistance as the partitioned members 22, 22′. As shown in the exploded perspective view of FIG. 5, the resin dummy member 24 includes outer frames 24a formed along the perimeter of the non-heat exchange air flow passage 25b and pillars 24b, which are placed between the outer frames 24a. The pillars 24b extend in the stacking direction (top to bottom direction in FIG. 2). The resin dummy member 24 has the shape of ladder when it is viewed from the air flow direction, as shown in FIG. 2.

Thus, because the resin dummy member 24 has the shape of ladder, the resin dummy member 24 can maintain a predetermined shape. Also, the ventilation flow resistance can be adjusted easily by changing the shape or the number of pillars 24b.

The details of the stacked structure of the parts 22, 22′, 23, 24 in the electrical heater 20 of the present embodiment are illustrated in FIGS. 4-5.

FIG. 4 is an exploded perspective view of an area E of the electrical heater 20 in FIG. 2. FIG. 5 is an exploded perspective view of an area F of the electrical heater 20 in FIG. 2.

As shown in FIG. 4, each PTC element 22a is received in and fixed in one of the holes 22b of the heating partition member 22. Thus, the air flow passage adjacent to the heating partition member 22 is the heat exchange air flow passage 25a (See part E of FIG. 2). Heat exchange fins 23 are placed on both sides of each heating partition member 22 as shown, for example, in part E of FIG. 2.

On the other hand, as shown in FIG. 5, no PTC element 22a is fixed to the hole 22b of the non-heating partition member 22′ located at part F of FIG. 2. Thus, the air flow passage heating partition member between the non-heating partition members 22′ is the non-heat exchange air flow passage 25b. The resin dummy member 24 is placed below the non-heating partition member 22′ at area F of FIG. 2, as shown in FIG. 5.

The PTC elements 22a in the heating partition member 22 are supplied with power through a terminal 26c installed in the housing 26a, an unillustrated electrode plate, and the metal heat exchange fin 23. An electrode plate that can directly supply power to the PTC elements 22a from the terminal 26c may be provided.

The operation of the electrical heater 20 is described below. The electrical heater 20 generates heat when supplied with electrical power from the control unit, when the vehicle air conditioner performs warming of air and the heater core 9 cannot sufficiently heat the air that passes though the evaporator 8. Therefore, because the electrical heater 20 can heat air being delivered to the passenger compartment, immediate heating of air is enabled in the vehicle air conditioner of the present embodiment.

Furthermore, in the electrical heater 20 of the present embodiment, the partition members 22, 22′ are spaced from one another and from the frame members 21 by equal intervals as shown in FIGS. 2-5. The heat output or capacity of the electrical heater 20 is set by placing only a predetermined number of the PTC elements 22a in corresponding ones of the holes 22b of the heating partition member 22. Therefore, the heat capacity or output of the electrical heater 20 can be adjusted easily without changing the frame or the shape of the heater 20.

Because the relatively expensive metal heat exchange fin 23 is not placed in the non-heat exchange air flow passage 25b, costs are reduced.

Furthermore, because the heating partition member 22 and the non-heating partition member 22′ are composed of the same plates, the cost of the electrical heater 20 is reduced.

The resin dummy member 24 is formed such that the ventilation flow resistance of the non-heat exchange air flow passage 25b is equivalent to the ventilation flow resistance that would exist if a heat exchange fin 23 were placed in the non-heat exchange air flow passage 25b. Because the resin dummy member 24 is placed in the non-heat air flow passage 25b the ventilation flow resistance of the electrical heater 20 does not change even when the heat output of the electrical heater 20 is adjusted by changing the number of PTC elements.

Also, because the resin dummy member 24 is made with resin, the cost of the electrical heater 20 is reduced.

### Other Embodiments

Although the present invention has been fully described in connection with the preferred embodiments thereof with reference to the accompanying drawings, various changes and modifications will become apparent to those skilled in the art.

(1) In the illustrated embodiment, the heating partition members 22 and the non-heating partition members 22′ are composed of the same parts for reducing costs. However the present invention is not so limited. The non-heating partition member 22′ may be composed of a plate that does not include the holds 22b.

(2) In the illustrated embodiment, the resin dummy member 24 is placed in the non-heat exchange air flow passage 25b. However, when it is not a problem that the ventilation flow resistance of the electrical heater 20 changes from one vehicle type to another when the heating output is varied, the resin dummy member 24 may be omitted.

In another variation, the non-heating partition member 22′ forming the non-heat exchange air flow passage 25b can be omitted, and the outer frame 24a of the resin dummy member 24 may be used as the non-heating partition member 22′ as shown FIG. 6. In this modification, the cost of the electrical heater 20 can be further reduced.

(3) In the illustrated embodiment, four heat exchange air flow passages 25a and one non-heat exchange air flow passage 25b are formed in the electrical heater 20 as shown in FIG. 2. However, the number of the heat exchange air flow passages 25a and non-heat exchange air flow passages 25b is not so limited. The number of the heat exchange air flow passages 25a and the non-heat exchange air flow passages 25b may be changed appropriately depending on the heat output of the electrical heater 20.

(4) In the illustrated embodiment, the electrical heater 20 is placed at the downstream side of the heater core 9. However, it may be placed in a foot duct (not shown) at the downstream side of the foot outlet 14 and leading the conditioned air toward the feet of the passengers. Further, the electrical heater 20 may be incorporated in the heater core 9.

(5) The electrical heater can be employed various ways without being limited to the vehicle air conditioner.

(6) In the illustrated embodiment, the non-heat exchange air flow passage 25b is formed between the non-heating partition members 22′. However, air flow between the non-heating partition members 22′ may be blocked.

(7) In the illustrated embodiment, the non-heat exchange air flow passage 25b is formed between the non-heating partition members 22′. However, the non-heat exchange air flow passage 25b may be formed between the non-heating partition members 22′ and the frame 21.

Such changes and modifications are to be understood as being within the scope as defined by the appended claims.

What is claimed is:

1. An electrical heater comprising:
a pair of frame members that are spaced apart by a predetermined distance;
a heating element that generates heat when energized;
a heating partition member for partitioning a space formed between the frame members and for fixing the heating element;
a non-heating partition member for partitioning a space formed between the frame members;
a heat exchange air flow passage located adjacent to the heating partition member;
a non-heat exchange portion located adjacent to the non-heating partition member and not adjacent to the heating partition member; and
a metal heat exchange member for facilitating heat transfer between the heating element and the air, wherein the heat exchange member is located only in the heat exchange air flow passage.

2. The electrical heater according to claim 1, wherein the non-heat exchange portion is an air flow passage through which air can pass.

3. The electrical heater according to claim 1, wherein the non-heating partition member is one of a pair of non-heating partition members, and the non-heat exchange portion is located between the non-heating partition members.

4. The electrical heater according to claim 1, wherein the heating partition member and the non-heating partition member substantially the same, and the heating partition member includes a portion for receiving the heating element.

5. The electrical heater according to claim 4, wherein the heating partition member is identical to the non-heating partition member except that no heating element is received by the non-heating partition member heating partition member.

6. The electrical heater according to claim 2, further comprising a ventilation flow resistance member placed in the non-heat exchange air flow passage, wherein the ventilation flow resistance member creates ventilation flow resistance against the air passing though the non-heat exchange air flow passage, and wherein the ventilation flow resistance of the non-heat exchange air flow passage per unit area is substantially the same as that of the heat exchange air flow passage.

7. The electrical heater according to claim 6, wherein the ventilation flow resistance member is generally ladder-shaped.

8. The electrical heater according to claim 6, wherein the ventilation flow resistance member is made with resin.

9. The electrical heater according to claim 1, wherein the heating element is a PTC element.

10. The electrical heater according to claim 1, further comprising a ventilation flow resistance member placed in the non-heat exchange air flow passage and for causing ventilation flow resistance against the air passing though the non-heat exchange air flow passage, wherein the ventilation flow resistance member comprises an outer frame member defining the non-heat exchange air flow passage, wherein the outer frame member serves as the non-heating partition member, and wherein a pillar is placed between opposed sections of the outer frame member.

11. The electrical heater of claim 1, wherein the electrical heater forms part of a vehicle air conditioner.

12. An electrical heater comprising:
a pair of frame members that are spaced apart by a predetermined distance;
a plurality of heating elements that generate heat when energized;
a plurality of partition members for partitioning a space formed between the frame members, wherein each of the partition members is adapted to receive at least one of the heating elements;
a heat exchange air flow passage, which is located adjacent to one of the heating elements;
a non-heat exchange air flow passage, which is spaced apart from each of the heating elements; and
a metal heat exchange member for facilitating heat transfer between the heating element and the air, wherein the heat exchange member is located only in the heat exchange air flow passage.
